(19) United States
(12) Patent Application Publication
(10) Pub. No.: US 2005/0093544 A1
(43) Pub. Date: May 5, 2005

(54) System for contactless moving or holding magnetic body in working space using magnet coil

(76) Inventor: Gunter Ries, Erlangen (DE)

Correspondence Address: STAAS & HALSEY LLP, SUITE 700, 1201 NEW YORK AVENUE, N.W., WASHINGTON, DC, 20005, US

(21) Appl. No.: 10/934,757

(22) Filed: Sep. 7, 2004

(30) Foreign Application Priority Data
Sep. 5, 2003 (DE) 10341092.9

(51) Int. Cl. G01V 3/00

(52) U.S. Cl. 324/318

(57) ABSTRACT

A magnetic body may be moved in a contactless fashion and fixed in a working space by a system with a magnet coil system of fourteen individual coils which can be driven individually for production of three magnetic field components and five magnetic field gradients. The system also includes a unit to detect the actual position and a unit to set a desired position of the magnetic body.

### CROSS REFERENCE TO RELATED APPLICATIONS

This application is based on and hereby claims priority to German Application No. 103 41 092.9 filed on 5 Sep. 2003, the contents of which are hereby incorporated by reference.

### BACKGROUND OF THE INVENTION

1. Field of the Invention

An aspect of the invention relates to a system for at least one of contactless moving and fixing, i.e., holding in position, a magnetic body in a three-dimensional working space that is surrounded by surfaces defined in a rectangular x,y,z coordinate system, using a magnet coil system which surrounds the working space.

2. Description of the Related Art

Use is made in medicine of endoscopes and catheters that are introduced via incisions or body orifices, and can be displaced in a longitudinal direction from outside and can thus be navigated only in one dimension. Light guides permit optical inspection, it being possible to use control wires to rotate an endoscope pipe and thus the viewing direction. It is possible thereby to construct devices for biopsies, in particular. However, the probes used in this case can be navigated only in limited fashion, particularly at branching points, and so contactless exertion of force from outside could be attended by an expansion of the field of application.

The publication “IEEE Transactions on Magnetics”, Vol. 32, No. 2, March 1996, pages 320 to 328 and U.S. Pat. No. 5,125,888 A disclose a magnet coil system for contactless magnetic control of a probe including six preferably superconducting individual coils which are arranged on the faces of a cube whose position is to be described mathematically in a rectangular x,y,z coordinate system. The aim of these coils is to produce variable field directions and field gradients, in order to guide and to move a catheter with magnetic material or magnetic implants for therapeutic purposes in a body, for example a human body, to be examined. However, it is not possible to achieve unrestricted navigational freedom of the magnetic body with the aid of a magnet coil system composed of six individual coils.

U.S. Pat. No. 6,241,671 B1 describes a magnet coil system having three coils, while U.S. Pat. No. 6,529,751 B2 describes an arrangement of a few permanent magnets that are arranged rotatably about a patient and whose field can be influenced by magnetic diaphragms, and which can produce a magnetic wave for moving a magnetic probe.

Also known, furthermore, are magnet coil systems having rotatable permanent magnets for controlling magnetic catheters, in particular with radiographic monitoring.

This related art does not address methods for stabilizing position by feedback; it is assumed that in a manner prescribed by field direction and gradient a magnetic probe body always bears against an inner surface inside a body to be examined.

WO 96/03795 A1 describes a method having additional pulse coils with the aid of which a magnetic probe is to be moved in a stepwise fashion by accurately defined current pulses under computer control.

So called video capsules that serve for inspecting the digestive tract are also known, for example, from the Journal “Gatrointestinal Endoscopy”, Vol. 54, No. 1, pages 79 to 83. In this case, the video capsule is moved by the natural intestinal movement; that is to say the movements and viewing direction are entirely random.

DE 101 42 253 C1 describes a corresponding video capsule that is equipped with a bar magnet and with video and other intervention devices. An external magnet coil system is intended to exert forces on the bar magnet for the purpose of navigation. Mention is made of a freely suspended, so-called helicopter mode with external control by a 6D mouse, a feedback of the force via the mouse, and a positional feedback by a transponder. No details emerge from the document as regards the implementation of the corresponding magnet coil system and the operation of its individual coils.

None of the systems mentioned above allows a magnetic body to be held in a free-floating manner at a predetermined point with the aid of magnetic fields. This is because, according to Earnshaw's Theorem (see “Transactions of the Cambridge Philosophical Society”, Vol. 7, 1842, pages 97 to 120), any such configuration is unstable in at least one spatial direction. This means that the magnetic body always rests on an inner surface in the working space, predetermined by the local field gradients, or it bends a wire-guided catheter in a desired direction.

### SUMMARY OF THE INVENTION

An aspect of the present invention is to specify a system by which a (ferro)magnetic body such as a bar magnet can be navigated and can be fixed in a stable contactless manner in accordance with the abovementioned DE-C1 document, that is to say with the body being aligned and with force being exerted on it, using a special magnet coil system which surrounds the working space. The alignment and the magnitude and direction of the force on the body are intended in this case to be prescribable from outside magnetically and without mechanical connection.

Another aspect of the invention is to serve the contactless movement and/or fixing of a magnetic body in a three-dimensional working space that is surrounded by surfaces defined in a rectangular x,y,z coordinate system. The system is in this case intended to contain the following parts, specifically
a) a magnet coil system which surrounds the working space and has fourteen individually drivable individual coils that are designed to produce the three magnetic field components Bₓ, B_{y} and B_{z} as well as five magnetic field gradients from the gradient matrix,

$$\begin{matrix}D & & & \\ & ↘ & & \\ & & ( \begin{matrix}\frac{ⅆ {B}_{x}}{ⅆ x} & \frac{ⅆ {B}_{y}}{ⅆ x} & \frac{ⅆ {B}_{z}}{ⅆ x} \\ \frac{ⅆ {B}_{x}}{ⅆ y} & \frac{ⅆ {B}_{y}}{ⅆ y} & \frac{ⅆ {B}_{z}}{ⅆ y} \\ \frac{ⅆ {B}_{x}}{ⅆ z} & \frac{ⅆ {B}_{y}}{ⅆ z} & \frac{ⅆ {B}_{z}}{ⅆ z}\end{matrix} ) & \\ & & & ↘\end{matrix}$$

which is symmetrical with reference to its diagonal D, the aim being to use the individual coils to produce two of the three diagonal elements of the gradient matrix, and to produce in each case one of the nondiagonal elements from the three gradient element pairs of the gradient matrix, which are symmetrical relative to the diagonal D,
b) a detection unit detecting the actual position of the magnetic body in the working volume, and
c) an adjustment unit adjusting the set position of the magnetic body, including
   c1) a device for setting the orientation, set position and movement direction, and
   c2) a way to set the coil currents in the individual coils, with the error between the set position and the actual position being processed.

It is assumed in the case of the magnet coil system to be used, surrounding the working space like a cage and thereby permitting access in the z direction, that the conditions rotH=0 and divB=0 imposed by the Maxwell equations—with the variables in bold in each case symbolizing vectors—always produce field gradients in pairs. It was found that of the three possible field components Bₓ, B_{y} and B_{z} of the possible nine field gradients dBₓ/dx, dBₓ/dy, dB_{z}/dz, dB_{y}/dx, dB_{y}/dy, dB_{y}/dz, dB_{z}/dx, dB_{z}/dy and dB_{z}/dz only five independent gradients are produced. In this case, it is then necessary for eight different current patterns corresponding to the magnetic degrees of freedom to be capable of being impressed on the fourteen individual coils, with currents of the same magnitude. These current patterns each predominantly produce a field component or a field gradient. It is then possible by superposition to produce any combination of magnetic field components and field gradients that is permitted by the Maxwell equations.

This allows a contactless alignment, which can be predetermined as required (=navigation including fixing) and a magnetic force on a magnetic body, for example a probe such as a catheter, endoscope or a video capsule which is connected to a magnetic element, in accordance with DE 101 42 253 C1, by magnetic fields in a working space.

The system according to the invention advantageously makes it possible to ensure interaction of position control for the magnetic body in the three spatial directions with the complex requirements for the field configuration, as is produced by the abovementioned magnet coil arrangement. Whenever the magnetic body is moved or rotated, the currents in this case change in all fourteen individual coils. The coil currents in the individual coils are in this case set such that the error between the set position and the actual position is reduced, in particular being minimized. The components used for setting and processing are designed appropriately.

Furthermore, the refinement with force feedback to the device for setting the orientation, set position and movement direction, as well as possible limiting of the speed at which the magnetic body is moved are advantageous. In particular, this allows free, stable floating (as is desirable for medical diagnosis) in a working space, for example of a video capsule which is equipped with a magnetic body in the form of a ferromagnet or permanent magnet, in accordance with the cited DE 101 42 253 C1, in a sample by active position control.

Thus, the fourteen individually drivable individual coils can be arranged on surfaces situated opposite in pairs, and on at least one tubular peripheral surface extending in the z direction. It is possible thereby for the surfaces to define a cuboid or cube except for the peripheral surface. However, they need not necessarily be planar. The individual coils situated on these surfaces then permit good access to the working space, in particular in the z direction.

It is advantageously possible in this case for at least six of the individual coils to be situated on the end-face or lateral surfaces, situated oppositely in pairs, of the working space, and to serve to produce the three magnetic field components Bₓ, B_{y}, B_{z} as well as the two diagonal elements of the gradient matrix. At the same time, at least four of the individual coils can be arranged distributed as seen in the circumferential direction on the at least one tubular peripheral surface surrounding the working space, and can serve to produce at least one nondiagonal element of the gradient matrix. The required three nondiagonal elements can be formed in this way together with the remaining individual coils.

In accordance with a particularly advantageous embodiment of the coil system, it is possible for
six of the individual coils to be situated as three coil pairs on the end-face or lateral surfaces, situated oppositely in pairs, of the working space, and for
eight of the individual coils to form two coil arrangements that can be situated seen in the z direction one behind the other on the at least one tubular peripheral surface, and whose respectively four individual coils can be arranged distributed seen in a circumferential direction on the peripheral surface, and can serve to produce three nondiagonal elements, located on one side of the diagonal, in the gradient matrix. This coil system is distinguished by a clear design with good accessibility to the working space in the z direction.

It is equally well possible instead of this to provide in the case of the coil system
that a coil pair of individual coils is situated on the end-face surfaces of the working space, and serves to produce the magnetic field component B_{z} as well as the diagonal element dB_{z}/dz of the gradient matrix,
that a coil arrangement composed in each case of two individual coils arranged one behind the other as seen in the z direction, is respectively situated on the lateral surfaces situated oppositely in pairs, and serves to produce the magnetic field component Bₓ or B_{y},
that a coil arrangement composed of four individual coils arranged distributed as seen in a circumferential direction is situated on the at least one tubular peripheral surface, and
that the coil arrangements on the lateral surfaces and the peripheral surface serve to produce a further diagonal element and three nondiagonal elements, located on one side of their diagonals, in the gradient matrix.

In the embodiments described above, the field gradient coils situated on the (imaginary) peripheral surface can advantageously be fashioned in the form of a saddle. It is possible in this case for the end-face arcuate parts running on the peripheral surface in a circumferential direction to be situated next to one another as seen in this circumferential direction, that is to say to assume an angle of arc of >90° in each case, or else for them to overlap. It is easy to manufacture appropriate individual coils which produce clear field conditions.

Moreover, at least a few of the field component coils can be fashioned as flat rectangular coils or circular coils. In particular, the coils located at the end faces thus permit good access to the working space in the z direction.

Parts composed of soft magnetic material can advantageously be assigned on the outer side of the coil system for the purpose of field amplification and/or field shielding.

In order to drive the fourteen individual coils of the magnet coils, it is advantageous to use a computer to drive its respectively assigned power supply as a function of the respective position of the magnetic body to be moved.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of a system for contactless movement and fixing/holding of a magnetic body;

FIG. 2 is a schematic perspective view of a first embodiment of a magnet coil system in the system illustrated in FIG. 1;

FIGS. 3a to 3h are schematic perspective views of the individual coils of the magnet coil system illustrated in FIG. 2 with current-conducting directions for producing predetermined magnetic field components and gradients;

FIG. 4 is a block diagram of a computer drive system for the individual coils of the magnet coil system illustrated in FIG. 2;

FIG. 5 is a schematic perspective view of a further embodiment of a magnet coil system, and

FIGS. 6a to 6i are schematic perspective views of the current-conducting directions in the individual coils of the magnet coil system illustrated in FIG. 5.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

A system according to the invention can be used to move a magnetic test specimen in a contactless fashion in a working volume and to hold it steady. In this case, the alignment as well as the magnitude and direction of the forces on this test specimen can be prescribed from outside magnetically and without mechanical connection. Particularly in medical applications, it is possible thereby for a probe fitted with such a magnetic test specimen to be a catheter or an endoscope having magnet elements or a small television camera with an illumination system and transmitter that transmits video images from the interior of the body such as, for example, the digestive tract or the lung. Moreover, ferromagnetic foreign bodies such as, for example, a needle or functional modules can be moved by magnetic forces in objects or spaces inaccessible from outside, or be removed therefrom. In addition to being applied in medicine, an inventive system can also be equally well used in other fields such as, for example in contaminated spaces. Assigned magnetic probes can also be used to inspect, for example internally, other, in particular inaccessible objects, it also being possible, of course, for the probes to be fitted with another or additional range of functions.

The magnet coil system used can thus be used to control the test specimen from outside by magnetic forces in all three lateral degrees of freedom and in a viewing direction with two rotational degrees of freedom. Moreover, the magnet coil system in this case advantageously permits access from outside in the z direction, for example in order to position persons to be treated in the interior of the working space.

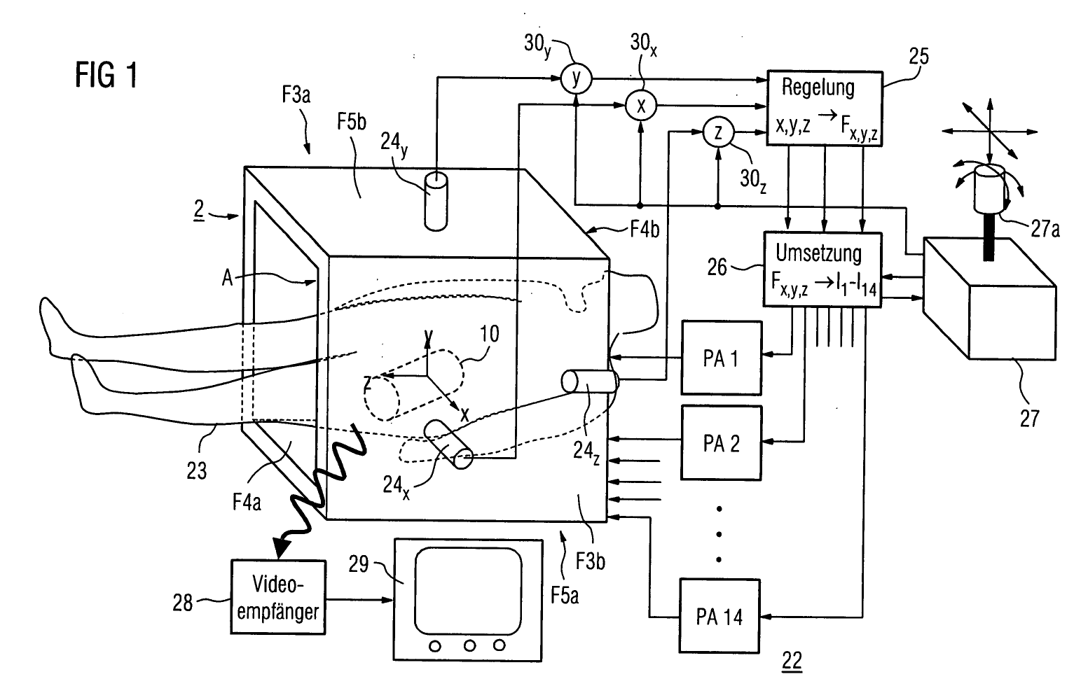

FIG. 1 shows, in the form of a block diagram, one exemplary embodiment of a system 22 for corresponding contactless navigation and fixing of a ferromagnetic body 10 in a sample or examination object 23, for example a person. The sample is in this case located in a working space A, which is surrounded by fourteen individual coils of a magnet coil system 2, which is not shown in any more detail in FIG. 1. The magnetic body 10, which is composed, for example, of ferromagnetic or permanent-magnetic material, may, in particular, be part of a probe, such as a video capsule according to the cited DE 101 42 253 C1.

The magnet coil system 2 in FIG. 1, which is not illustrated in any more detail has, for example, an approximately cubic outer contour. The corresponding six cube faces are denoted by F3a, F3b, F4a, F4b, F5a and F5b. Let a rectangular x,y,z coordinate system be associated with the cube. The faces F4a and F4b situated orthogonally to the z direction can be in this case be regarded as end-face surfaces, while then the pairs of surfaces F3a, F3b and F5a, F5b, respectively orthogonal to the x axis and to the y axis, can be regarded as pairs of lateral faces. The pairs of surfaces enclose an inner or working space A that is fashioned in three dimensions.

For active position control of the magnetic body 10, the system 2 may use conventional components for detection of the actual position of the body 10 in the working space A. By way of example, three position measurement devices 24ₓ, 24_{y} and 24_{z}, may be used to determine the position of the body 10 in the respective coordinate directions. The corresponding measured values are supplied to a control device 25, which is part of means for setting a set position of the magnetic body. For this purpose, the control device has three control loops for the x, y and z positions, which allow an opposing force to be applied to the magnetic body 10 in the x, y and z directions from the control error between the actual position and the set position. The control device 25 is followed by a converter unit 26. This converter unit 26 controls fourteen power supply units PA1 to PA14, by which the currents I₁ to I₁₄ are produced in the fourteen individual coils of the magnet coil system 2. A defined field direction and magnetic force F=grad(m B) (where m is the vector of the magnetic moment in the body) are produced on the magnetic body 10 in the coil system. In this case, adjustment forces (which are derived from the position control) in the three coordinate directions are converted into magnetic fields and gradients as well as further coil currents, which exert these forces on the magnetic body. Errors in the set position are thus counteracted, and the position of the body is stabilized. During free floating, the weight force and any further forces which may occur are set as a consequence of this in order to overcome mechanical resistances. The polar angles/coordinates θ and φ of the orientation and/or the set position and/or the movement direction in the three spatial coordinates are predetermined by a device 27 for setting the orientation, set position and movement direction of the magnetic body 10, for example in the form of a joystick with a control column 27a, or a 6D mouse. To do this, the actuator 27 produces the set positions x, y and z and compares them in respectively associated comparators 30ₓ, 30_{y} and 30_{z} with the actual position, which is obtained from the measurement signals from the position measurement devices 24ₓ, 24_{y} and 24_{z}. The difference values are passed as control errors to the control device 25, where they are amplified, processed further in the control sense, and are supplied to the converter device 26, where current values for the fourteen coil power supply units PA1 to PA14 are calculated using mathematical methods from the values supplied in this way, by which changed field gradients and thus magnetic forces Fₓ, F_{y} and F_{z} are produced on the magnetic body 10. These forces counteract the control error of the body in its position x, y and z. Furthermore, the actuator 27 passes to the converter device 26 the set directions using polar angles θ and φ in space, which are converted there to the currents for the three field components Bₓ, B_{y} and B_{z}, and are passed appropriately to the coil system 2 via the power supply units PA1 to PA14.

FIG. 1 furthermore indicates a device by which the video signal is received from a video capsule which is equipped with a magnetic body 10. For this purpose, the device contains a video receiver 28 as well as a monitor 29.

The system 2 may advantageously also be designed such that the force (which is calculated in the converter device 26) on the magnetic body 10 exerts a proportional force effect on the joystick 27a of the device via actuating elements in the actuator 27. This allows, for example, undesirable magnetic resistance on the body 10 to be sensed by an operator of the actuator, for example an examining doctor.

In a further refinement of the system, the speed of the magnetic body 10 can advantageously be detected from a position measurement by differentiation, and can be fed into the control loop with the aim of limiting this speed. This makes it possible, for example, to prevent damage caused by the magnetic body striking walls, for example in the body interior of the sample 23.

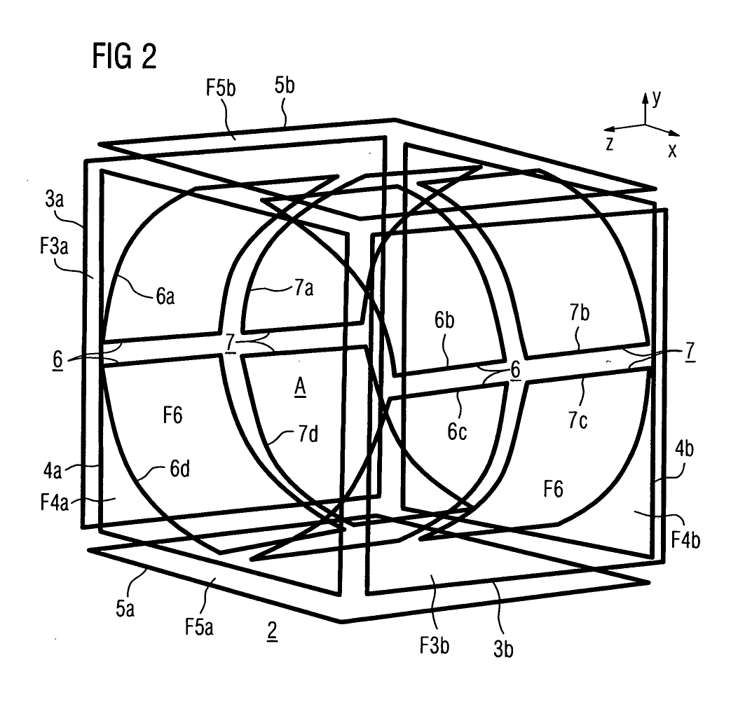

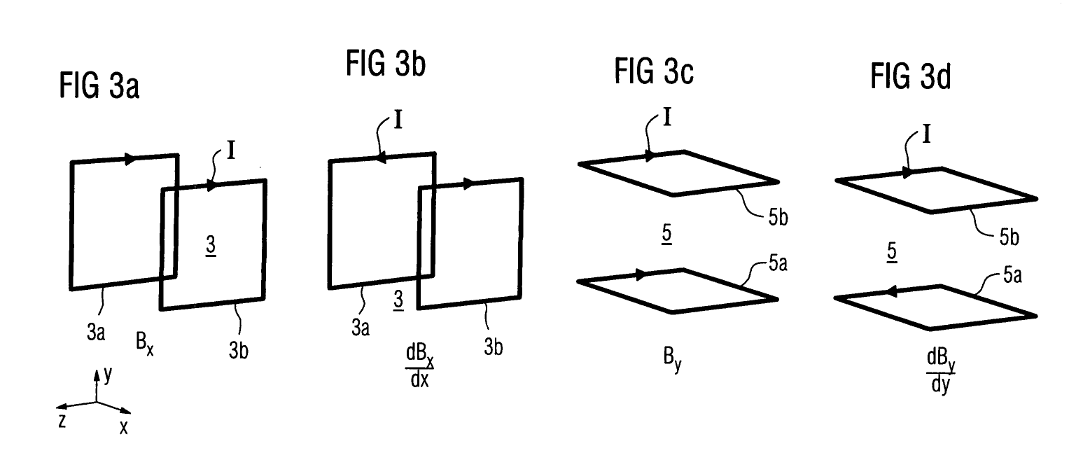

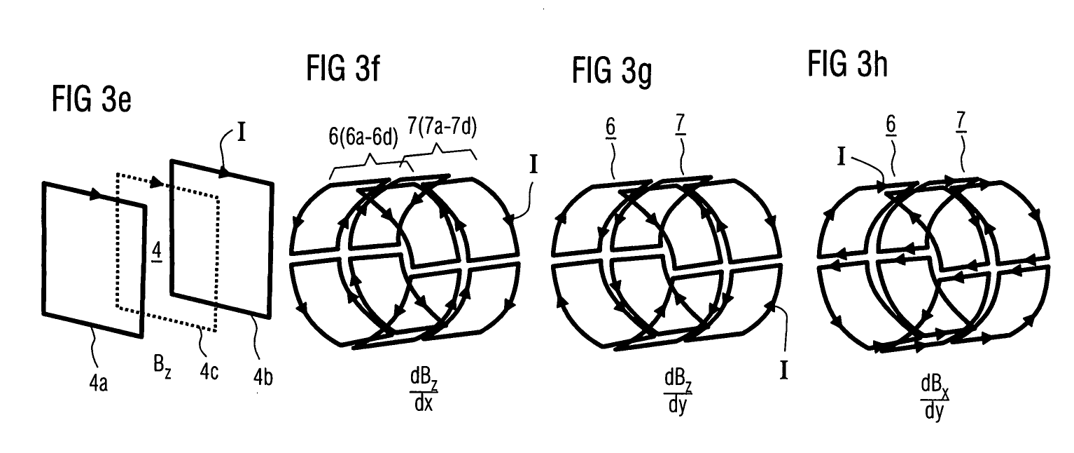

Details of a typical exemplary embodiment of a magnet coil system 2 for a system 22 according to the invention are illustrated schematically in FIGS. 2 and 3a-3h.

The magnet coil system 2 includes fourteen normally conductive or superconducting individual coils that are preferably constructed as rectangular or saddle coils. In this case, the winding forms are illustrated merely schematically in FIG. 2; it is also possible to select individual coils with rounded corners, circular coils or other forms of coil. The coil system of the selected exemplary embodiment is assembled from in this case of six field component coils 3a, 3b, 4a, 4b and 5a, 5b, as well as eight field gradient coils 6a to 6d and 7a to 7d. The field component coils 3a, 3b and 4a, 4b and 5a, 5b situated in pairs on the opposite cube faces F3a, F3b; F4a, F4b and F5a, F5b can be used to produce the field components Bₓ, B_{y}, B_{z} as well as at least two of the three diagonal magnetic field gradients dBₓ/dx, dB_{y}/dy and dB_{z}/dz from the gradient matrix reproduced below. This gradient matrix with a diagonal D is as follows:

$$\begin{matrix}D & & & \\ & ↘ & & \\ & & ( \begin{matrix}\frac{ⅆ {B}_{x}}{ⅆ x} & \frac{ⅆ {B}_{y}}{ⅆ x} & \frac{ⅆ {B}_{z}}{ⅆ x} \\ \frac{ⅆ {B}_{x}}{ⅆ y} & \frac{ⅆ {B}_{y}}{ⅆ y} & \frac{ⅆ {B}_{z}}{ⅆ y} \\ \frac{ⅆ {B}_{x}}{ⅆ z} & \frac{ⅆ {B}_{y}}{ⅆ z} & \frac{ⅆ {B}_{z}}{ⅆ z}\end{matrix} ) & \\ & & & ↘\end{matrix}$$

Let a line joining the elements dBₓ/dₓ, dB_{y}/d_{y} and dB_{z}/d_{z} be regarded in this case as the diagonal D on the gradient matrix. The gradient matrix is constructed symmetrically with reference to this diagonal D or to the abovementioned magnetic field gradients situated on it. In this case, the sum of the diagonal elements is equal to zero. In accordance with FIGS. 3a-3h, the coil pairs, together with current-conducting directions to be selected in them, producing the individual field components are denoted by 3 and 4 and 5, respectively. The pairs of the field component coils are preferably arranged orthogonally relative to one another. They are generally of the same form, at least in pairs.

The field gradient coils 6a to 6d and 7a and 7d fashioned in the form of saddles are used in each case to construct two coil arrangements 6 and 7 that are arranged in series as seen in the z direction. In terms of field, the saddle-shaped field gradient coils enclose the working space A, in which case they are arranged jointly on at least one imaginary tubular peripheral surface F6 with an axis running parallel to the z direction. Seen in a circumferential direction, the gradient coils belonging to a coil arrangement are mutually spaced; that is to say there is an interspace in each case between their end-face arcuate parts and thus between their longitudinal sides running in the z direction. However, it is also possible for neighboring gradient coils to overlap with their longitudinal sides. The imaginary peripheral surface F6 has a circular cross section, for example. However, it can also have another, for example square, cross-sectional shape. Also conceivable are concentric peripheral surfaces on which the individual coils from one or from both coil arrangements are located. Neither need the at least one peripheral surface F6 necessarily be situated inside the space enclosed by the field component coils 3a, 3b, 4a, 4b, 5a, 5b, but they can also enclose the structure made from these coils, if appropriate. In general, at least the field gradient coils belonging to a coil arrangement 6 and/or 7 are of the same form. In general, the surfaces which have been mentioned are imaginary surfaces. However, the individual coils (which extend on them) of the magnet coil system 2 are, of course, held by a physical fixing structure, not illustrated in the drawings.

With the aid of the field gradient coils 6a to 6d and 7a to 7d, the magnetic field gradients dBₓ/dy, dB_{z}/dx and dB_{z}/dy are to be constructed in accordance with FIGS. 3a-3h, for example, given selection of the illustrated current-conducting directions. These three field gradients in each case constitute a nondiagonal element of the above gradient matrix. Here, these elements respectively originate from another element pair, symmetrical relative to the diagonal D. To be precise, during the construction of corresponding field gradients the field gradients symmetrical relative to the diagonal D are necessarily produced in pairs. In this case, these would be the gradients dB_{y}/dx and dBₓ/dz and dB_{y}/dz, respectively. Since only five degrees of gradient freedom are to be taken into account, there is also no need for any special current pattern for the dB_{z}/dz field gradients. As an alternative, however, it is possible to produce the dB_{z}/dz field gradient, and in return to omit one of the gradients dBₓ/dx or dB_{y}/dy. That is to say, only two of the three gradients situated on the diagonal D of the gradient matrix need be produced.

If an elongated magnetic body, for example a ferromagnet or permanent magnet, that is connected to a probe, for example, is now introduced into the working space A of the magnet coil system 2, it tends to be aligned parallel to the field direction, thereby also prescribing the alignment of the probe. The field gradients in this case exert a force F=grad(m·B) on the magnetic body, m being the vector of the magnetic moment of the magnetic body. By driving each of the fourteen individual coils in a targeted fashion, it is then possible to align the magnetic body arbitrarily in the working space A, and also to exert on it a prescribed force F in all directions, that is to say the body can not only be rotated, but also moved linearly.

FIGS. 3a to 3h show in pairs the fourteen individual coils of a magnetic coil system, for example of the system 2 according to FIG. 2, in an individual illustration with the respective flow directions of the currents I for producing the field components and field gradients required for contactless movement and/or rotation. Here, in accordance with FIGS. 3a and 3b, the coil pair 3 of the individual coils 3a, 3b can be used in accordance with the flow direction to produce the magnetic field component Bₓ or the field gradient dBₓ/dx. In a corresponding way, the individual coils 5a, 5b of coil pair 5 are to be used to form the field component B_{y} or the field gradient dB_{y}/dy. The coil pair 4 composed of the individual coils 4a and 4b produces the field component B_{z} in accordance with FIG. 3e. In accordance with FIGS. 3f to 3h, the two coil arrangements 6 and 7 composed of the in each case four gradient coils 6a to 6d and 7a to 7d, respectively, are used according to the current-conducting direction in the individual coils to produce the field gradients dB_{z}/dx and dB_{z}/dy and dBₓ/dy, respectively.

In addition to the field components respectively desired, each current pattern also produces other field components in the magnet coil system. These other field components are a function of the respective coil measurements and of the location of the magnetic body; their amplitude increases from the center outward in the direction of the windings of the coils. That is to say, there is thus no simple relationship between the current intensity of the current pattern with the field direction and force direction F=grad(m·B) at a location of the magnetic body.

However, it is possible by suitably overlapping the eight current patterns in the fourteen individual coils to set at a location of the magnetic body (probe location) precisely those fields and field gradients that produce the desired alignment and action of force on the magnetic body. It is possible with particular advantage, for example, to implement free suspension of the magnetic body in the space precisely when the weight force F=m g=grad(m·B) is produced (M=mass, g=acceleration due to gravity). The calculation in this regard is advantageously performed using a computer that, in particular, carries out the following computations and, if appropriate, repeats them continuously during a movement of the magnetic body:
calculation of the desired values for the three field components Bₓ, B_{y}, B_{z} at the location of the magnetic body from a prescribed direction of the magnetic body in polar coordinates θ and φ in the working space, and from the modulus |B|;
calculation of the desired values for the five independent field gradients dBₓ/dx, dB_{y}/dy, dBₓ/dy, dB_{z}/dx and dB_{z}/dy from a prescribed magnetic force on the magnetic body; it is also possible to prescribe the gradient dB_{z}/dz and in so doing to cause one of the other gradients dBₓ/dx or dB_{y}/dy situated on the diagonal of the gradient matrix to vanish. Also conceivable are superimpositions of the gradient dB_{z}/dz with one of the other diagonal gradients dBₓ/dx or dB_{y}/dy;
calculation of field components and field gradients at the location of the magnetic body for each of the eight current patterns from the coil geometry, for example for a 1 A coil current, and representation in the form of an 8×8 matrix;
calculation of an inverse matrix. This inverse matrix is a function only of the coil geometry, and can be set up in advance for each point on an array in the prescribed working space. During operation of the device, interpolation is carried out between the values in this array for the purpose of quicker calculations;
multiplication of the inverse matrix for the location of the magnetic body by the field vector (Bₓ, B_{y}, B_{z}, dBₓ/dx, dB_{y}/dy, dBₓ/dy, dB_{z}/dx, dB_{z}/dy) produces the current values for the eight current patterns;
dividing the current patterns over the fourteen individual coil currents in accordance in each case with a positive or negative current direction from a stored table, and linear superimposition of the currents in the individual coils;
driving the fourteen power supply units for the individual coils;
monitoring the limits of power loss in the individual coils.

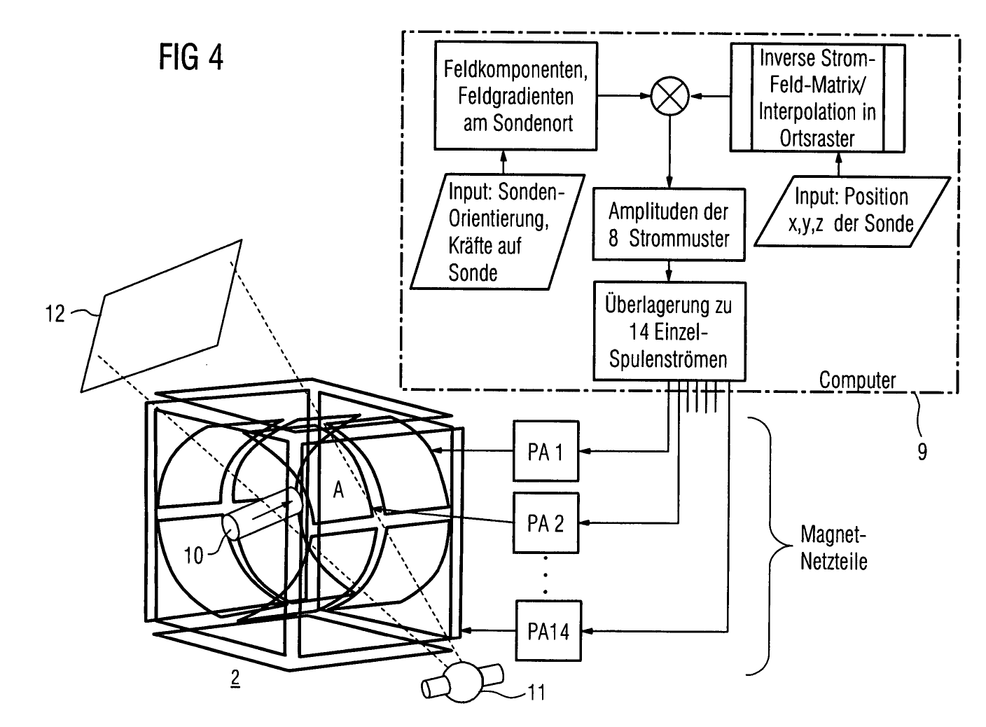

A schematic illustration of a device for driving the fourteen individual coils in cooperation with an imaging device for monitoring the position of the magnetic body or probe is provided in FIG. 4. A computer that drives the magnetic coil system 2 of FIG. 2 is denoted by 9. In addition to a freely prescribable field direction, unrestricted magnetic forces are also be exerted on a magnetic body or a corresponding probe 10 in all three spatial directions with the aid of the fourteen individual coils of the magnet coil system. The computer 9 drives the fourteen power supply units PA1 to PA14 for the fourteen individual coils. Furthermore, FIG. 2 also indicates an X-ray tube 11 of an X-ray unit whose radiation transradiates the free space between the windings of the individual coils. The position or movement of the magnetic body 10 is then to be observed on a display screen 12 outside the magnet coil system.

The following measures can be provided for the purpose of a specific configuration of the magnet coil system in accordance with the illustrations in the drawings:
The individual coils can be wound from aluminum or copper strip and be liquid-cooled, if appropriate.
The individual coils can be fabricated from hollow metal profiles through the interior of which a cooling medium is led, if appropriate.
In particular, the individual coils can be made from superconducting conductors, preferably with the aid of a high-T_{c} superconductor material.
Of course, further individual coils can also be used, for example, to homogenize the magnetic field. A corresponding individual coil is indicated by dashes in FIG. 3e and denoted by 4c. It homogenizes the field component B_{z} in space.
Moreover, magnetic material can be assigned to the magnet coil system. For example, the system may be surrounded at least partly by parts made from such material. A corresponding configuration of the magnet coil system 2 according to FIG. 2 provides magnetic return bodies made from soft magnetic material such as iron; they surround the gradient coils of the system 2 from the outside. Field amplification in the working space A and/or stray field shielding to the outside, in particular, can be achieved with such soft magnetic parts.
If appropriate, it is possible to select different conductor cross sections for the individual coils of a coil pair in order to produce the magnetic field components or a coil arrangement for producing the field gradients. Thus, for example, an upper y individual coil, for example the individual coil 5b according to FIG. 3c, can have a larger conductor cross section or an increased number of turns per unit length by comparison with the lower y coil 5a assigned to it. Of course, such a different configuration is also possible for the other coil pairs and/or coil arrangements.

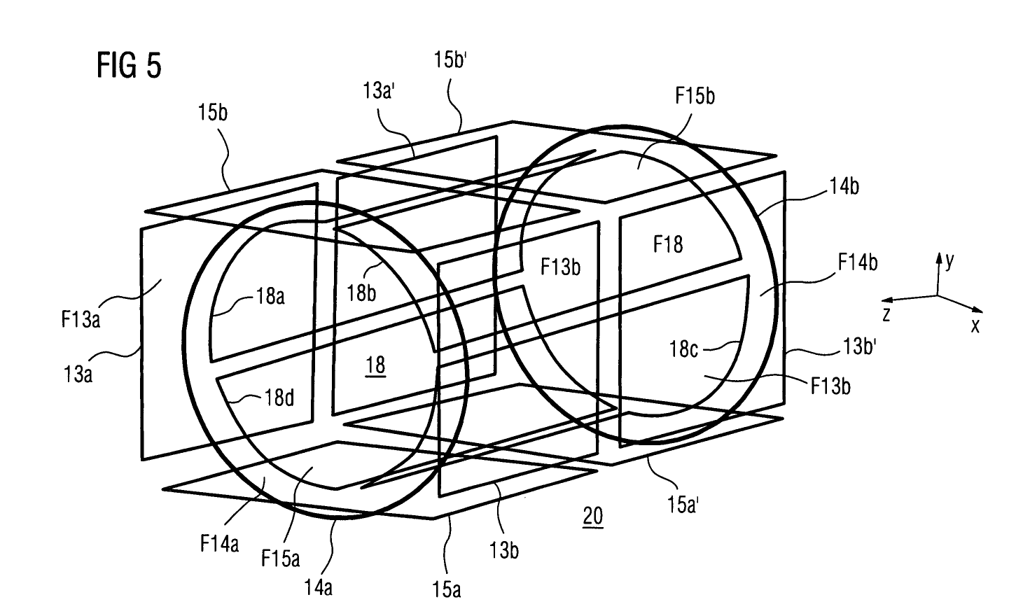

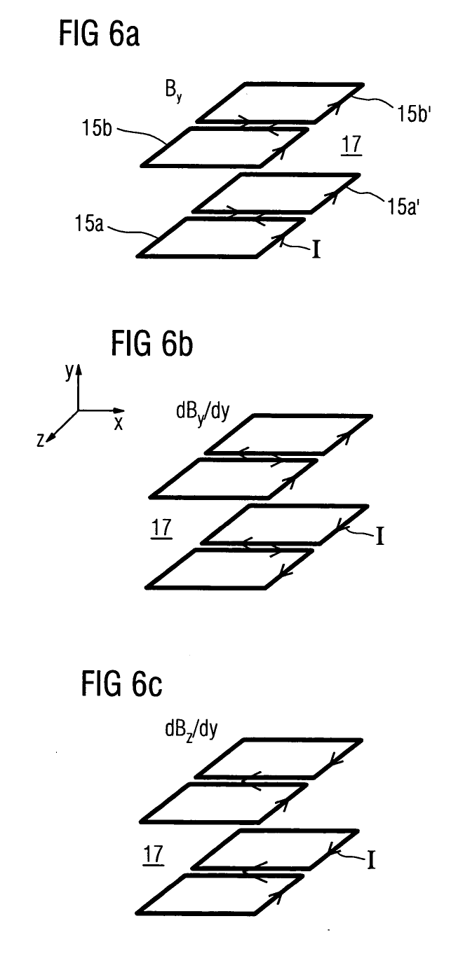

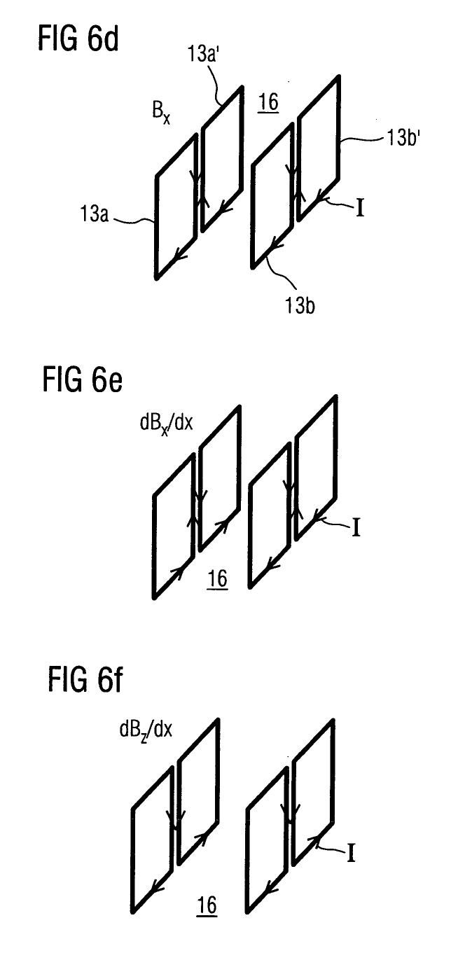

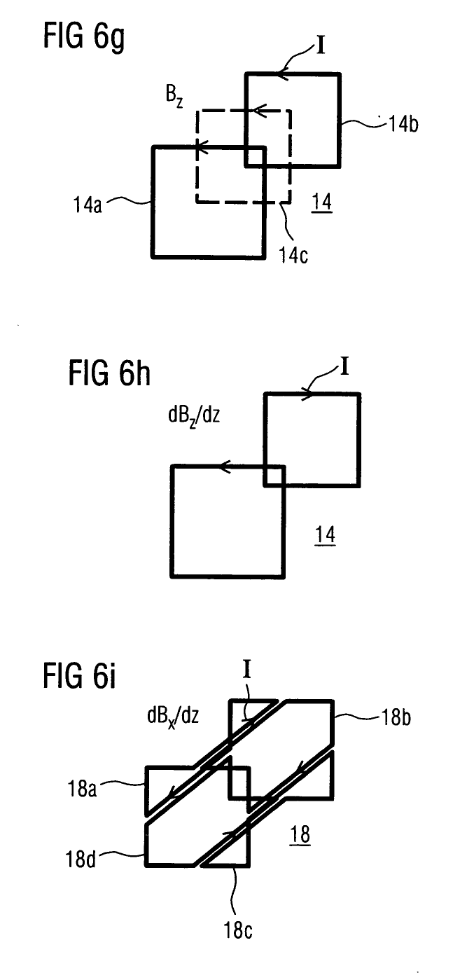

In the case of the exemplary embodiments, illustrated in the above drawings, of the inventive magnetic coil system 2, it has been assumed that in addition to the field components Bₓ, B_{y} and B_{z} the field component coils arranged orthogonally in pairs on opposite faces of a cube can also be used to produce two of the three diagonal field gradients in accordance with the above gradient matrix. However, it is possible, furthermore, also to use field component coils to generate nondiagonal field gradients. It is necessary for this purpose that two of the three field component coils are formed by coil pairs composed of individual coils. Such an embodiment can be provided, in particular, whenever the magnet coil system has a squarer contour around a working space. A corresponding exemplary embodiment of a magnet coil system having, in turn, fourteen individual coils is indicated in FIGS. 5 and 6 in the representation corresponding to FIGS. 2 and 3, and denoted by 20. Here, FIGS. 6a to 6i show the current-conducting directions to be selected in the individual coils for the magnetic field components and gradients. In the case of this embodiment, a coil pair 14 composed of individual coils 14a and 14b is situated on end-face surfaces F14a and F14b of the working space A. In accordance with FIGS. 6g and 6h, the magnetic field component B_{z} and the associated gradient element dB_{z}/dz can be produced on the diagonal D of the gradient matrix with the aid of these, for example circularly, individual coils. By contrast, the field component coils to be arranged on lateral surfaces F13a, F13b and F15a, F15b situated opposite in pairs are formed in each case by a coil arrangement 16 or 17, respectively, composed in each case of two individual coils arranged in series as seen in the z direction. In accordance with FIG. 6d, the coil arrangement 16 is assembled in this case from the individual coils 13a, 13a′ as well as 13b and 13b′, respectively. In accordance with FIGS. 6d, 6e and 6f, the field component Bₓ or the diagonal gradient element dBₓ/dx and the nondiagonal gradient element dB_{z}/dx are then to be produced in these individual coils depending on the current-conducting direction. In accordance with FIGS. 6a to 6c, it is possible in a corresponding way to use the individual coils 15a, 15a′ and 15b, 15b′ of the coil arrangement 17 on the lateral surfaces F15a and F15b to produce the field component B_{y} or the diagonal gradient element dB_{y}/dy and the nondiagonal gradient element dB_{z}/dy. In order to be able to produce the third one of the nondiagonal gradient elements dBₓ/dy in accordance with FIG. 6i, there is also a need for a further coil arrangement 18 composed of four individual coils 18a to 18d. These individual coils are situated on an (imaginary) tubular peripheral surface F18, extending parallel to the z axis and enclosing the working space A, inside the contour formed by the field component coils. These four individual coils 18a to 18d are arranged in a uniformly distributed fashion as seen in the circumferential direction of the peripheral surface F18, it being possible, if appropriate, for their longitudinal sides running in the z direction to overlap. A square cross-sectional shape has admittedly been assumed for the imaginary peripheral surface in the illustration according to FIG. 6i. However, as may be seen from FIG. 7, it is also possible to provide other shapes for this purpose. Furthermore, in the FIG. 6g, the possibility, also addressed in relation to FIG. 3e, is indicated of providing further individual coils for the purpose of homogenizing the magnetic field. Thus, an appropriate homogenization of the field component B_{z} can be achieved with the aid of the individual coil denoted by 14c and executed with dashes in the drawings.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1. A system for at least one of contactless movement and holding position of a magnetic body in a working space in three-dimensions that is surrounded by surfaces defined in a rectangular x,y,z coordinate system, comprising:
a magnet coil system surrounding the working space and having at least fourteen individually drivable individual coils that are designed to produce three magnetic field components Bₓ, B_{y} and B_{z} as well as five magnetic field gradients from a gradient matrix
$$( \begin{matrix}\frac{ⅆ {B}_{x}}{ⅆ x} & \frac{ⅆ {B}_{y}}{ⅆ x} & \frac{ⅆ {B}_{z}}{ⅆ x} \\ \frac{ⅆ {B}_{x}}{ⅆ y} & \frac{ⅆ {B}_{y}}{ⅆ y} & \frac{ⅆ {B}_{z}}{ⅆ y} \\ \frac{ⅆ {B}_{x}}{ⅆ z} & \frac{ⅆ {B}_{y}}{ⅆ z} & \frac{ⅆ {B}_{z}}{ⅆ z}\end{matrix} )$$
which is symmetrical with reference to its diagonal, using the individual coils to produce two of three diagonal elements of the gradient matrix, and producing in each case one of nondiagonal elements from three symmetrical gradient element pairs of the gradient matrix which are symmetrical relative to a diagonal;
means for detection of an actual position of the magnetic body; and
means for setting a set position of the magnetic body, including
a device for setting orientation, set position and movement direction of the magnetic body, and
means for setting coil currents in the individual coils based on processing of an error between the set position and the actual position of the magnetic body.

2. The system as claimed in claim 1, wherein said means for detection of the actual position of the magnetic body is arranged within the working space.

3. The system as claimed in claim 2, wherein said means for detection includes at least one position measurement device associated with a respective coordinate.

4. The system as claimed in claim 3, wherein said device for setting the orientation, set position and movement direction of the magnetic body is a joystick or a six dimensional mouse.

5. The system as claimed in claim 4, wherein said means for setting the coil currents in the individual coils includes
a computer with an associated control device, connected to said detection means; and
an associated converter device arranged downstream from the control device.

6. The system as claimed in claim 5, wherein said means for setting the coil currents in the individual coils further includes fourteen individual power supply units, following the associated converter device, producing independent currents.

7. The system as claimed in claim 6, wherein the fourteen individually drivable individual coils of said magnet coil system are arranged on surfaces in opposing pairs and on at least one tubular peripheral surface extending in a z-direction.

8. The system as claimed in claim 7, wherein said magnet coil system includes
at least six of the individual coils, situated in opposing pairs on at least one of end-face and lateral surfaces of the working space, producing the three magnetic field components Bₓ, B_{y}, B_{z} as well as two diagonal elements of the gradient matrix; and
at least four of the individual coils, distributed along a circumference of the at least one tubular peripheral surface surrounding the working space, producing at least one nondiagonal element of the gradient matrix.

9. The system as claimed in claim 7, wherein said magnet coil system includes
six of the individual coils situated as three opposing pairs on at least one of end-face and lateral surfaces of the working space; and
eight of the individual coils in two coil arrangements, each two coil arrangement aligned in the z-direction on the at least one tubular peripheral surface, and in four coil arrangements, each four coil arrangement distributed along a circumference of the at least one tubular peripheral surface surrounding the working space, producing three nondiagonal elements located on one side of diagonals in the gradient matrix.

10. The system as claimed in claim 7, wherein said magnet coil system includes
a coil pair of individual coils, situated on end-face surfaces of the working space, producing the magnetic field component B_{z} as well as diagonal element dB_{z}/dz of the gradient matrix;
a coil arrangement of four pairs of individual coils, the individual coils in each pair aligned in the z-direction, respectively situated on the lateral surfaces in opposing pairs, producing one of the magnetic field components Bₓ and B_{y}, a further diagonal element and three nondiagonal elements located on one side of a diagonal in the gradient matrix; and
a coil arrangement of four individual coils distributed along a circumference of the at least one tubular peripheral surface.

11. The system as claimed in claim 7, wherein the at least one tubular peripheral surface of the magnet coil system is located inside an inner space defined by lateral surfaces arranged in opposing pairs.

12. The system as claimed in claim 7, wherein said magnet coil system includes field gradient coils, having a saddle shape, on a plurality of tubular peripheral surfaces.

13. The system as claimed in claim 12, wherein the field gradient coils of each coil arrangement of said magnet coil system have end-face arcuate parts at least one of abutting and overlapping in a circumferential direction.

14. The system as claimed in claim 7, wherein said magnet coil system includes at least two field component coils fashioned as flat rectangular coils or circular coils.

15. The system as claimed in claim 7, wherein said magnet coil system includes at least one of coil pairs and coil arrangements respectively formed from individual coils of identical shape.

16. The system as claimed in claim 15, wherein the coil pairs are arranged orthogonally relative to one another in said magnet coil system to produce the magnetic field components.

17. The system as claimed in claim 7, wherein said magnet coil system includes parts formed of soft magnetic material on outer sides providing at least one of field amplification and field shielding.

18. The system as claimed in claim 1, wherein said means for detection includes at least one position measurement device associated with a respective coordinate.

19. The system as claimed in claim 1, wherein said device for setting the orientation, set position and movement direction of the magnetic body is a joystick or a six dimensional mouse.

20. The system as claimed in claim 1, wherein said means for setting the coil currents in the individual coils includes
a computer with an associated control device, connected to said detection means; and
an associated converter device arranged downstream from the control device.

21. The system as claimed in claim 1, wherein the fourteen individually drivable individual coils of said magnet coil system are arranged on surfaces in opposing pairs and on at least one tubular peripheral surface extending in a z-direction.

22. The system as claimed in claim 1, wherein said magnet coil system includes at least two field component coils fashioned as flat rectangular coils or circular coils.

23. The system as claimed in claim 1, wherein said magnet coil system includes coil pairs arranged orthogonally relative to one another to produce the magnetic field components.

24. The system as claimed in claim 1, wherein said magnet coil system includes parts formed of soft magnetic material on outer sides providing at least one of field amplification and field shielding.
